(19) United States
(12) Patent Application Publication
(10) Pub. No.: US 2009/0171900 A1
(43) Pub. Date: Jul. 2, 2009

(54) PRINTER DRIVER FOR TRANSACTION RECORD STORAGE

(75) Inventors: Brian Phillips, San Francisco, CA (US); Hugo Olliphant, San Francisco, CA (US); George Lee, Mountain View, CA (US); Matthew Mengerink, San Jose, CA (US)

Correspondence Address: Haynes and Boone, LLP;IP Section, 2323 Victory Avenue, SUITE 700, Dallas, TX, 75219, US

(73) Assignee: eBay Inc.

(21) Appl. No.: 11/966,883

(22) Filed: Dec. 28, 2007

(51) Int. Cl. G06F 7/10; G06Q 10/00; H04L 9/32; G06F 17/30

(52) U.S. Cl. 707/3; 705/30; 707/10; 726/5; 707/E17.032; 707/E17.014

(57) ABSTRACT

A printer driver may be used to pass transaction information to a remote location for storage. Such transaction information may pertain, for example, to online transactions performed by a user in relation to various online merchants. Such transactions, for example, may also be facilitated by a payment service provider. In one example, a method of processing transaction information includes receiving transaction information at a client device. The transaction information is associated with a user-merchant transaction. The method also includes receiving a user-initiated selection of a printer driver. The method further includes, in response to the selection, passing the transaction information to a remote location to store the transaction information in a transaction record maintained at the remote location. The passing is performed by software implemented in the printer driver. Related methods, devices, and systems are also disclosed.

### BACKGROUND

1. Field of the Invention

The present invention generally relates to online transaction receipts, financial documents, and other sensitive and time-dependent documents.

2. Related Art

Customers routinely search for and purchase products and services through electronic communications with online merchants over electronic networks such as the Internet. In this regard, individual consumers may frequently engage in transactions with a variety of merchants through, for example, various merchant websites.

During the course of these transactions, merchants may provide customers with receipts or other records. It is generally the consumer's responsibility to locally store these merchant receipts typically in paper form for future reference. Unfortunately, the maintenance of such paper records can be burdensome, especially for customers that engage in large numbers of transactions. Even when such transaction records are stored locally in electronic form, the burden nevertheless falls on customers to maintain such electronic storage.

These problems become increasingly difficult for customers to manage as the number of user-merchant transactions and the number of visited merchant websites increase. Consequently, consumers may be unable to consistently maintain satisfactory records.

### SUMMARY

As will be further described herein in relation to various embodiments, a printer driver may be used to pass transaction information to a remote location for storage. Such transaction information may pertain, for example, to online transactions performed by a user in relation to various online merchants. Such transactions, for example, may also be facilitated by a payment service provider.

In accordance with an embodiment of the invention, a method of processing transaction information includes receiving transaction information at a client device. The transaction information is associated with a user-merchant transaction. The method also includes receiving a user-initiated selection of a printer driver. The method further includes, in response to the selection, passing the transaction information to a remote location to store the transaction information in a transaction record maintained at the remote location. The passing is performed by software implemented in the printer driver.

In accordance with another embodiment of the invention, a client device includes one or more processors and one or more memories adapted to store a plurality of machine-readable instructions. When executed by the one or more processors, the machine-readable instructions are adapted to cause the client device to: receive transaction information associated with a user-merchant transaction; receive a user-initiated selection of a printer driver; and in response to the selection, pass the transaction information to a remote location to store the transaction information in a transaction record maintained at the remote location. The transaction information is passed by software implemented in the printer driver.

In accordance with another embodiment of the invention, a machine-readable medium comprising a plurality of machine-readable instructions is provided. When executed by one or more processors of a client device, the machine-readable instructions are adapted to cause the client device to provide a printer driver. The printer driver is adapted to pass transaction information to a remote location to store the transaction information in a transaction record maintained at the remote location. The printer driver is adapted to pass the transaction information in response to a user-initiated selection of the printer driver received by the client device. The transaction information is received by the client device and is associated with a user-merchant transaction.

In accordance with another embodiment of the invention, a method of managing transaction information includes maintaining a plurality of transaction records. The transaction records comprise transaction information associated with a plurality of user-merchant transactions. The method also includes receiving new transaction information from a client device in response to a triggering of a printer driver performed at the client device. The new transaction information is associated with a new user-merchant transaction. The method further includes storing the new transaction information in a new transaction record.

In accordance with another embodiment of the invention, a transaction record processing system includes a plurality of transaction records associated with the user accounts. The transaction records comprise transaction information associated with a plurality of user-merchant transactions. The transaction record processing system also includes one or more processors and one or more memories adapted to store a plurality of machine-readable instructions. When executed by the one or more processors, the machine-readable instructions are adapted to cause the transaction record processing system to: receive new transaction information associated with a new user-merchant transaction from a client device in response to a triggering of a printer driver performed at the client device; and store the new transaction information in a new transaction record.

These and other features and advantages of the present invention will be more readily apparent from the detailed description of the embodiments set forth below taken in conjunction with the accompanying drawings.

### BRIEF DESCRIPTION OF THE FIGURES

FIG. 1 illustrates a block diagram of a networked system configured to provide transaction record storage in accordance with an embodiment of the invention.

FIG. 2 illustrates a transaction process in accordance with an embodiment of the invention.

FIG. 3A illustrates a sample user interface displayed to a user during the process of FIG. 2 in accordance with an embodiment of the invention.

FIG. 3B illustrates another sample user interface displayed to a user during the process of FIG. 2 in accordance with an embodiment of the invention.

FIG. 4 illustrates a process of retrieving transaction records in accordance with an embodiment of the invention.

FIG. 5 illustrates a sample user interface displayed to a user during the process of FIG. 4 in accordance with an embodiment of the invention.

Like element numbers in different figures represent the same or similar elements.

### DETAILED DESCRIPTION

In accordance with various embodiments disclosed herein, transaction information associated with various user-merchant transactions can be conveniently passed from a user device to a remote location by a printer driver in order to store the transaction information in transaction records maintained at the remote location. For example, in one embodiment, a user may print transaction information such as a receipt or other document using software that is perceived by the user as a printer driver. Advantageously, such software may be configured to store the transaction information in accordance with various techniques described herein.

In one embodiment, the remote location may be a server of a payment service provider or another entity. The transaction records can be subsequently retrieved by the user through the user device. For example, in one embodiment, the user may view transaction information at a client device received from an online merchant or payment service provider. Then, the user may trigger a storage of the transaction information using a printer driver by selecting a print operation through an appropriate interface provided by the user device. In response, the printer driver may pass the transaction information to the payment service provider for storage. Advantageously, this approach permits transaction records of any printable format to be conveniently stored by the payment service provider. The transaction records may be subsequently retrieved by the user on demand.

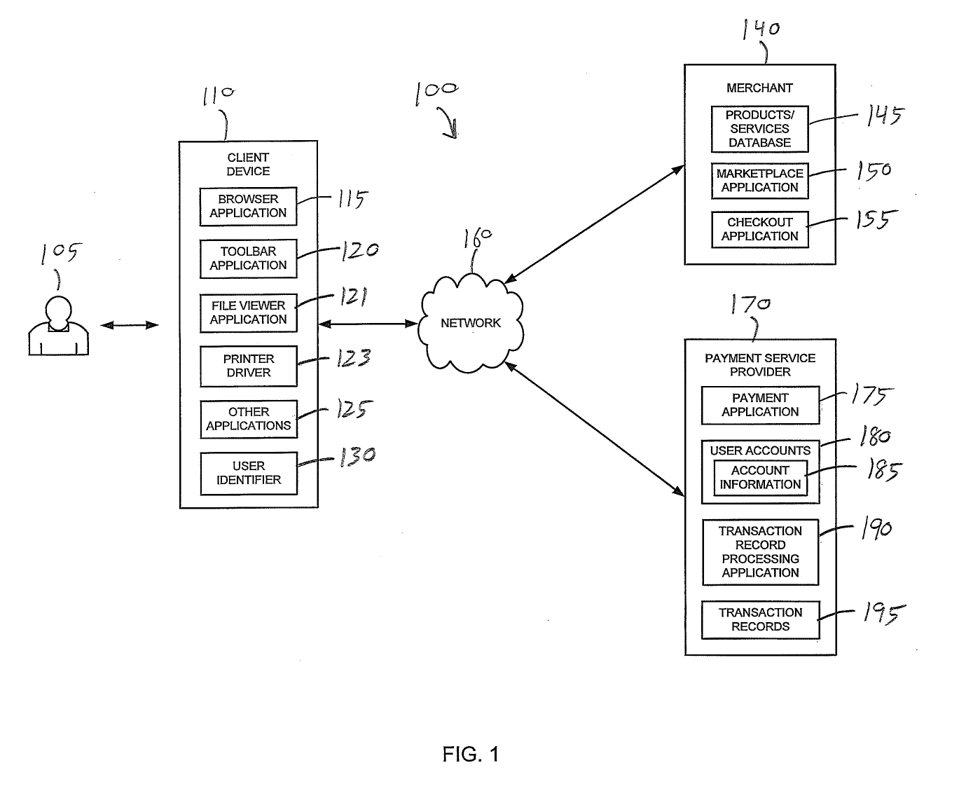

Referring now to the drawings wherein the showings are for purposes of illustrating embodiments of the present invention only, and not for purposes of limiting the same, FIG. 1 illustrates a block diagram of a networked system 100 configured to provide transaction record storage in accordance with an embodiment of the invention. As shown, system 100 includes a client device 110, a merchant server 140, and a payment service provider server 170 in communication over a network 160.

Client device 110, merchant server 140, and payment service provider server 170 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of system 100, and/or accessible over network 160.

Network 160 may be implemented as a single network or a combination of multiple networks. For example, in various embodiments, network 160 may include the Internet or one or more intranets, landline networks, wireless networks, and/or other appropriate types of networks.

Client device 110 may be implemented using any appropriate combination of hardware and/or software configured for wired and/or wireless communication over network 160. For example, in one embodiment, client device 110 may be implemented as a personal computer of a user 105 (e.g., a customer) in communication with the Internet. In other embodiments, client device 110 may be implemented as a wireless telephone, personal digital assistant (PDA), notebook computer, and/or other types of computing devices.

As shown, client device 110 may include one or more browser applications 115 which may be used, for example, to provide a convenient interface to permit user 105 to browse information available over network 160. For example, in one embodiment, browser application 115 may be implemented as a web browser configured to view webpages or other content available over the Internet.

Client device 110 may also include one or more toolbar applications 120 which may be used, for example, to provide client-side processing for performing desired tasks in response to operations selected by user 105. In one embodiment, toolbar application 120 may display a user interface in connection with browser application 115. In this regard, toolbar application 120 may be configured to receive input commands from user 105 instructing client device 110 to capture transaction information displayed by browser application 115, send transaction information to a printer driver, and/or perform other tasks.

Client device 110 may also include one or more file viewer applications 121 that may be used to display transaction information stored in files of various formats to user 105. For example, in one embodiment, file viewer application 121 may be implemented as a word processing application configured to display word processing files comprising transaction information. In another embodiment, file viewer application 121 may be implemented as a graphics application configured to display graphic files comprising transaction information. In yet another embodiment, file viewer application 121 may be implemented as an email application configured to display email messages comprising transaction information. In yet a further embodiment, file viewer application 121 may be implemented as a multimedia application configured to display any desired type of multimedia files comprising transaction information. In another embodiment, client device 110 may include a plurality of file viewer applications 121 used to display different file types.

Client device 110 may also include a printer driver 123 that may be used to provide transaction information from client device 110 to payment service provider server 170 for storage. In this regard, printer driver 123 may be software that is recognized by client device 110 as a device driver, but is implemented to send transaction information to payment service provider server 170 for storage, not merely for physical printing of the transaction information.

Accordingly, in one embodiment, if an application of client device 110 (for example, browser application 115, toolbar application 120, file viewer application 121, or other applications 125) attempts to print transaction information using printer driver 123 (for example, in response to a command by user 105), printer driver 123 may be implemented to send the transaction information to payment service provider server 170 over network 160, rather than actually print the transaction information to a physical printer. In another embodiment, printer driver 123 may be implemented to both send the transaction information to payment service provider server 170 over network 160 and also print the transaction information to a printer in communication with client device 110.

Client device 110 may further include other applications 125 as may be desired in particular embodiments to provide desired features to client device 110. For example, in various embodiments, such other applications 125 may include security applications for implementing client-side security features, programmatic client applications for interfacing with appropriate application programming interfaces (APIs) over network 160, or other types of applications.

As also shown in FIG. 1, client device 110 includes one or more user identifiers 130 which may be implemented, for example, as operating system registry entries, cookies associated with browser application 115, identifiers associated with hardware of client device 110, or other appropriate identifiers. In one embodiment, user identifier 130 may be used by a payment service provider to associate user 105 with a particular account maintained by the payment service provider as further described herein.

Merchant server 140 may be maintained, for example, by an online merchant offering various products and/or services in exchange for payment to be received over network 160. In this regard, merchant server 140 includes a products/services database 145 identifying available products and/or services which may be made available for viewing and purchase by user 105. Accordingly, merchant server 140 also includes a marketplace application 150 which may be configured to serve information over network 160 to browser 115 of client device 110. For example, in one embodiment, user 105 may interact with marketplace application 150 through browser application 115 over network 160 in order to search and view various items identified in products/services database 145.

Merchant server 140 also includes a checkout application 155 which may be configured to facilitate the purchase by user 105 of items identified by marketplace application 150. In this regard, checkout application 155 may be configured to accept payment information from user 105 and/or from payment service provider server 170 over network 160. In various embodiments, checkout application 155 and/or marketplace application 150 may be configured to send transaction information to client device 110 as email messages, web pages, or other data formats.

Payment service provider server 170 may be maintained, for example, by an online payment service provider which may provide payment on behalf of user 105 to the operator of merchant server 140. In this regard, payment service provider server 170 includes one or more payment applications 175 which may be configured to interact with client device 110 and/or merchant server 140 over network 160 to facilitate the purchase of items by user 105 from merchant server 140. In various embodiments, payment application 175 may also be configured to send transaction information to client device 110 as email messages, web pages, or other data formats. In one embodiment, payment service provider server 170 may be provided by PayPal, Inc.

Payment service provider server 170 also maintains a plurality of user accounts 180, each of which may include account information 185 associated with individual users. For example, in one embodiment, account information 185 may include private financial information of user 105 such as account numbers, passwords, credit card information, bank information, or other financial information which may be used to facilitate online transactions by user 105. Advantageously, payment application 175 may be configured to interact with merchant server 140 on behalf of user 105 during a transaction with checkout application 155 without requiring user 105 to provide account information 185 to merchant server 170.

Payment service provider server 170 also provides a transaction record processing application 190 which may be configured to receive transaction information from printer driver 123 over network 160 and store the transaction information in a plurality of transaction records 195 which are associated with individual user accounts 180. As further described herein, transaction records 195 may be implemented to store transaction information associated with particular online transactions between user 105 and merchant server 140 (i.e., user-merchant transactions). Accordingly, payment service provider server 170 can provide centralized storage of transaction information. Transaction record processing application 190 may also be configured to serve particular transaction records 195 to client device 110 in response to requests by user 105.

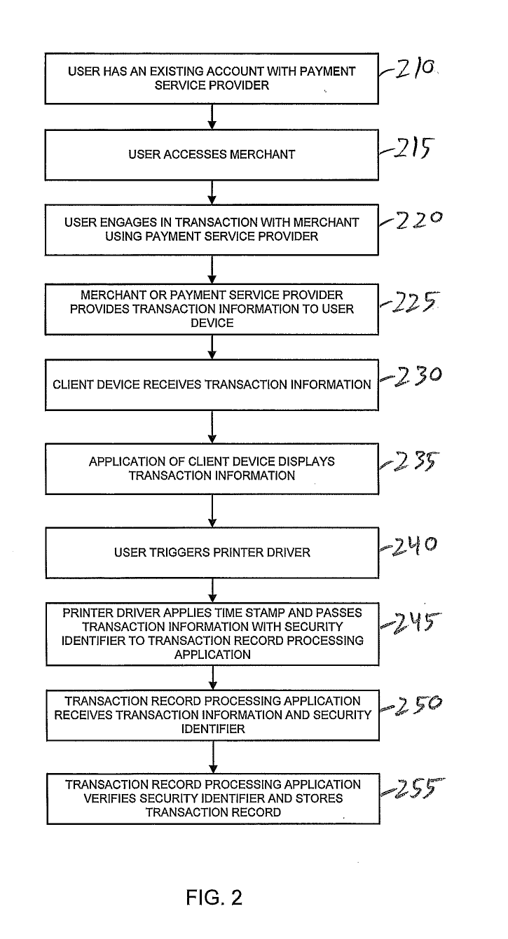

FIG. 2 illustrates a transaction process in accordance with an embodiment of the invention. In initial step 210, it is assumed that user 105 has previously registered with payment service provider server 170 to open a user account 180. In this regard, it will be appreciated that user 105 may have previously provided account information 185 to payment service provider server 170 over network 160 through, for example, a secure connection between client device 110 and payment service provider server 170.

As a result of such previous registration, client device 110 stores a user identifier 130 that may be used to identify the particular user 105 as having a user account 180 maintained by payment service provider server 170. As previously described, user identifier 130 may be implemented, for example, as one or more cookies, operating system registry entries, hardware identifiers, or other types of identifiers.

In step 215, user 105 accesses an online marketplace provided by merchant server 140. For example, in one embodiment, user 105 may use browser application 115 to access a webpage provided by marketplace application 150 of merchant server 140. In this regard, marketplace application 150 may be configured to display various items identified in products/services database 145. Also in step 215, user 105 may optionally select such items for purchase through interaction between browser application 115 and checkout application 155.

Then, in step 220, user 105 engages in a transaction with merchant server 140 to purchase various items selected during previous step 215. In this regard, user 105 may authorize an operator of payment service provider server 170 to provide relevant financial information (e.g., account information 185 from one of user accounts 180 associated with user 105) for executing such transactions on behalf of user 105. In one embodiment, client device 110 may interact with merchant server 140 during step 220. In another embodiment, payment service provider server 170 may interact with merchant server 140 on behalf of client device 110 and user 105 during step 220.

In step 225, merchant server 140 or payment service provider server 170 provides information associated with the transaction performed in previous step 220. Such transaction information may be provided in various formats such as HTML, XML, other text-based formats, one or more webpages, email messages, graphic files, multimedia files, or other data formats. For example, in one embodiment, merchant server 140 or payment service provider server 170 may provide a webpage including transaction details to client device 110 which may be viewed by user 105 through browser application 115. In another embodiment, merchant server 140 or payment service provider server 170 may provide an email message to client device 110 identifying such transaction details. In one embodiment, the transaction information provided in step 225 may include program code, such as JavaScrip™ code embedded in a webpage, that is executable by client device 110.

In various embodiments, the transaction information provided in step 225 may include, for example, line item details for particular items purchased in the transaction of step 220, links to one or more webpages maintained by merchant server 140 that are associated with particular purchased items, personal or financial information of user 105, user identifier 130, identification information of a particular merchant, merchant policy terms (e.g., individual merchant return policies), shipping information, various terms and conditions (e.g., warranty information, return policies, price guarantees, and/or other information) associated with items purchased by users, or other information.

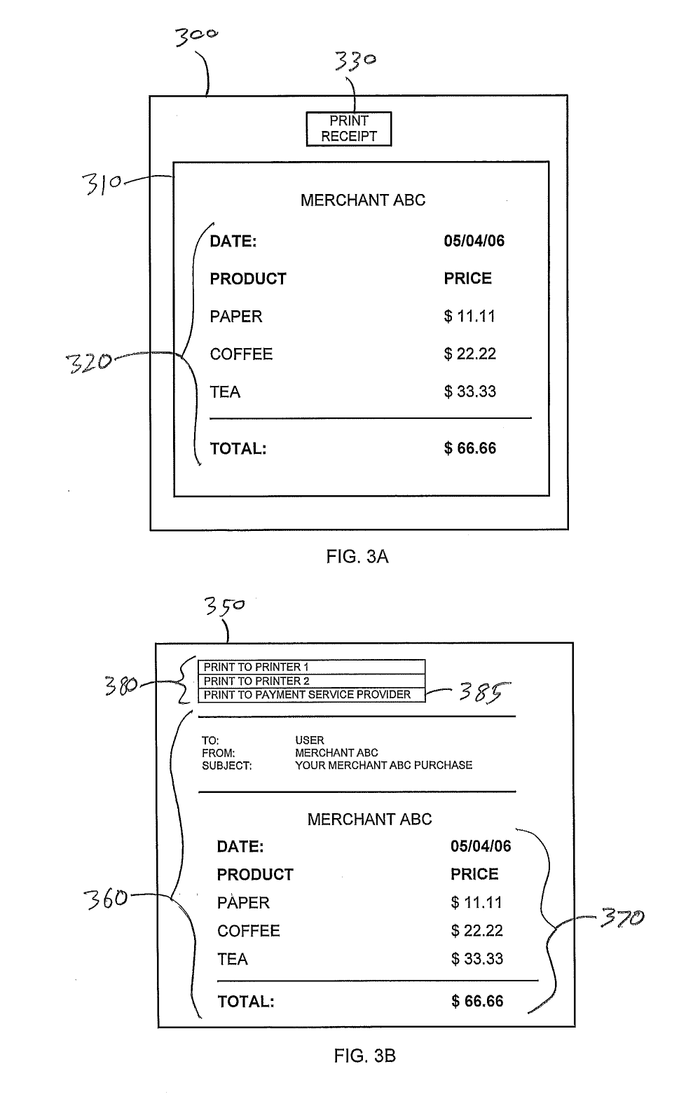

Client device 110 receives the transaction 140 (step 230) and displays the transaction information using an appropriate one of the applications of client device 110 (step 235). For example, FIG. 3A illustrates a sample user interface 300 that may be displayed to user 105 on client device 110 by browser application 115 for displaying transaction information in step 235. In this regard, user interface 300 includes a browser window 310 provided by browser application 115 to display a dynamically created webpage. As shown, browser window 310 includes various product descriptions 320 provided by marketplace application 150 which correspond to various products purchased by user 105 during step 220.

As another example, FIG. 3B illustrates a sample user interface 350 that may be displayed to user 105 on client device 110 by file viewer application 121 for displaying transaction information in step 235. In this regard, user interface 350 displays an email message 360. As shown, email message 360 includes various product descriptions 370 provided by marketplace application 150 which correspond to various products purchased by user 105 during step 220.

In step 240 of FIG. 2, user 105 triggers operation of printer driver 123 by interacting with client device 110 to select printer driver 123. For example, in one embodiment, user 105 may perform step 240 by selecting an appropriate button 330 displayed in user interface 300 by toolbar application 120 as shown in FIG. 3A. In another embodiment, user 105 may perform step 240 by selecting an appropriate menu item 385 displayed in a menu 380 of user interface 350 by file viewer application 121 as shown in FIG. 3B. In other embodiments, user 105 may perform step 240 using any appropriate type of interaction with client device 110 to select printer driver 123 including but not limited to entering a text-based command, selecting a physical button provided by client device 110 (e.g., a print screen button), or other appropriate interactions.

As previously discussed, printer driver 123 may be software that is recognized by client device 110 as a device driver, but is implemented to provide transaction information from client device 110 to payment service provider server 170 for storage. Accordingly, in response to step 240, printer driver 123 passes the transaction information to payment service provider server 170 over network 160 (step 245).

Also in step 245, printer driver 123 may apply a timestamp to the transaction information passed to payment service provider server 170. In this regard, the transaction information stored in transaction records 195 by payment service provider 170 may bear a timestamp (e.g., text, graphics, and/or other identifiers attached, embedded, and/or otherwise associated with the transaction information) corresponding to a time and/or date when step 245 is performed. Such a timestamp may be used as evidence of the time and/or date when the transaction information was recorded. Such evidence can be useful, for example, where the transaction information comprises legal documents, government documents, student homework, time-sensitive material, and/or other types of documents.

Advantageously, such a timestamp can permit users and/or other parties to tie (e.g., correlate or otherwise associate) transaction records 195 with other copies of the transaction information (e.g., paper records or other hard copies of the transaction information which are created at approximately the same time and/or date as the timestamped version of the transaction information).

Access to transaction records 195 may be controlled by payment service provider server 170 to prevent the storage or retrieval of transaction records 195 by other parties without the permission of user 105. In this regard, payment service provider server 170 may require the receipt of a security identifier such as a valid password, user identifier 130, username, and/or other appropriate information before transaction records 195 may be stored, changed, and/or retrieved. Accordingly, in addition to the transaction information, printer driver 123 may also pass an appropriate security identifier to payment service provider server 170 in step 245 to authorize, authenticate, and/or otherwise permit printer driver 123 to cause payment service provider server 170 to store the transaction information.

In this regard, the security identifier will be known by payment service provider server 170 and may be established in various ways. For example, in one embodiment, the security identifier may be embedded in printer driver 123 when printer driver 123 is installed on client device 110. In another embodiment, printer driver 123 may prompt user 105 to enter a security identifier when printer driver 123 is installed on client device 110. In another embodiment, printer driver 123 may prompt user 105 to enter a security identifier in response to step 240. In another embodiment, the security identifier itself may be additionally protected by an appropriate password or other security measure.

In another embodiment, the security identifier may be used to provide alternate types of access to transaction records 195. For example, the security identifier may be used provide limited access to only a subset of transaction records 195 associated with a particular one of user accounts 180. In this regard, the security identifier may be recognized by transaction record processing application 190 as providing access to only transaction records 195 that are associated with a particular user account 180 and also include transaction information concerning a particular merchant, service provider, or other entity. As a result, user 105 may provide other parties with limited access to the user's transaction records 195 as desired. As one example, a security identifier may be used to provide a landlord with limited access to a particular one of transaction records 195 to establish proof of an on-time rent payment by user 105. However, it will be appreciated that any desired type of limited access to transaction records 195 is contemplated by the present disclosure.

In step 250, transaction record processing application 190 receives the transaction information and security identifier passed by printer driver 123. In step 255, transaction record processing application 190 verifies the security identifier and, if valid, stores the captured transaction information as one of transaction records 195 associated with the particular user account 180 of user 105.

It will be appreciated that by performing the process of FIG. 2 for a plurality of transactions by user 105 with merchant server 140 and/or other merchants, a plurality of transaction records 195 may be stored by payment service provider server 170 and associated with an appropriate user account 180 associated with user 180. Such transaction records 195 may be subsequently accessed by user 105 as may be desired.

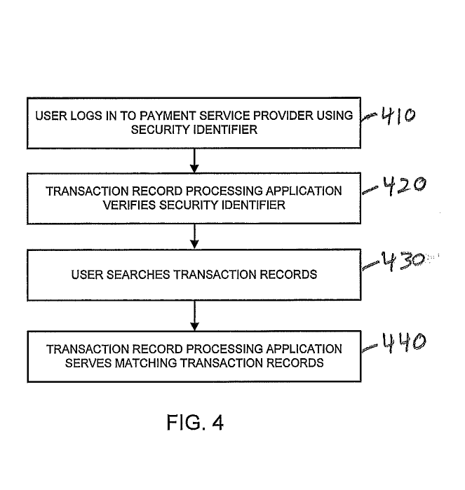

FIG. 4 illustrates a process of retrieving transaction records 195 in accordance with an embodiment of the invention. The process of FIG. 4 may be performed following the process of FIG. 2.

In step 410, user 105 logs in to payment service provider server 170 using a security identifier as previously discussed in order to authenticate user 105 for accessing the particular transaction records 195 associated with one of user accounts 180. For example, in one embodiment, user 105 may interact with payment service provider server 170 through an appropriate browser interface provided by browser application 115. In step 420, transaction record processing application 190 verifies the security identifier. If valid, the process of FIG. 4 continues to step 430 in which payment service provider server 170 may permit user 105 to enter one or more search terms for searching the contents of transaction records 195. In response to a search request entered by user 105, transaction record processing application 190 of payment service provider server 170 retrieves and serves any of transaction records 195 matching the search terms to client device 110 for display to user 105 by browser application 115 (step 440).

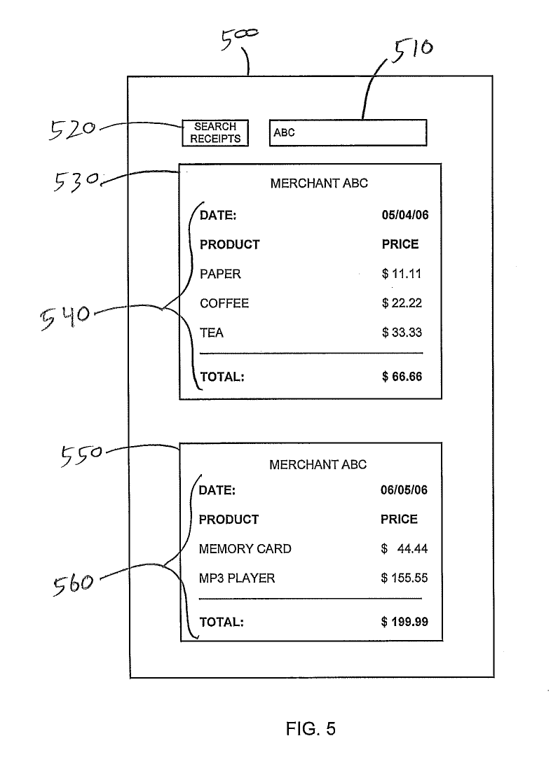

For example, FIG. 5 illustrates a sample user interface 500 that may be displayed to user 105 on client device 110 by browser application 115 for viewing transaction record search results provided in step 440. In this regard, user interface 500 includes a search window 510 into which user 105 may enter desired search terms. A user-operable button 520 is also provided which may cause transaction record processing application 190 to search transaction records 195 for the terms entered in search window 510.

In the embodiment illustrated in FIG. 5, transaction record processing application 190 has returned two particular transaction records 530 and 550 associated with the search term “ABC” entered in search window 510. In this regard, it will be appreciated that transaction records 530 and 550 each include various transaction information 540 and 560, respectively, associated with different transactions executed by user 105 in relation to a particular merchant (“Merchant ABC”). Accordingly, it will be appreciated that in this embodiment merchant server 140 may be maintained by Merchant ABC. However, it will also be appreciated that a plurality of merchant servers 140 associated with different merchants may also be provided as part of system 100.

In view of the present disclosure, it will be appreciated that various methods and systems have been described for receiving, sending, storing, and retrieving transaction records associated with online transactions. Advantageously, printer driver 123 permits user 105 to trigger remote storing of transaction information by payment service provider server 170 using a print operation of any desired one of the applications provided on client device 110. As a result, transaction information in a plurality of printable data formats may be conveniently stored and later retrieved by user 105 as desired.

Although various components and steps have been described herein as being associated with client device 110, merchant server 140, and payment service provider server 170 of FIG. 1, it is contemplated that the various aspects of such servers illustrated in FIG. 1 may be distributed among a plurality of servers, devices, and/or other entities. For example, in one embodiment, transaction record processing application 190 and transaction records 195 may be implemented by an entity separate from payment service provider server 170. Accordingly, in such an embodiment, communications described herein performed in relation to transaction record processing application 190 and transaction records 195 may be provided to a separate entity and need not be routed through payment service provider server 170 in all instances.

Where applicable, various embodiments provided by the present disclosure can be implemented using hardware, software, or combinations of hardware and software. Also where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

Software in accordance with the present disclosure, such as program code and/or data, can be stored on one or more computer readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure.

Having thus described embodiments of the invention, persons of ordinary skill in the art will recognize that changes may be made in form and detail without departing from the scope of the invention. Thus the invention is limited only by the claims.

What is claimed is:

1. A method of processing transaction information, the method comprising:
receiving transaction information at a client device, wherein the transaction information is associated with a user-merchant transaction;
receiving a user-initiated selection of a printer driver; and
in response to the selection, passing the transaction information over a network to a remote location to store the transaction information in a transaction record maintained at the remote location, wherein the passing is performed by software implemented in the printer driver.

2. The method of claim 1, further comprising applying a timestamp to the transaction information prior to the passing.

3. The method of claim 1, wherein the transaction information comprises a receipt implemented as one of an email message, a webpage, or a graphic file.

4. The method of claim 1, wherein the passing comprises passing a security identifier with the transaction information to the remote location to permit the transaction information to be stored at the remote location.

5. The method of claim 1, further comprising:
providing a search request from the client device to the remote location; and
receiving at the client device at least a portion of the transaction information from the remote location in response to the search request.

6. The method of claim 1, wherein the remote location comprises a payment service provider server.

7. A machine-readable medium comprising a plurality of machine-readable instructions which when executed by one or more processors of the client device are adapted to cause the client device to perform the method of claim 1.

8. A client device comprising:
one or more processors; and
one or more memories adapted to store a plurality of machine-readable instructions which when executed by the one or more processors are adapted to cause the client device to:
receive transaction information, wherein the transaction information is associated with a user-merchant transaction,
receive a user-initiated selection of a printer driver, and
in response to the selection, pass the transaction information to a remote location to store the transaction information in a transaction record maintained at the remote location, wherein the transaction information is passed by software implemented in the printer driver.

9. The client device of claim 8, wherein the machine-readable instructions when executed by the one or more processors are adapted to cause the client device to apply a timestamp to the transaction information before the transaction information is passed to the remote location.

10. The client device of claim 8, wherein the transaction information comprises a receipt implemented as one of an email message, a webpage, or a graphic file.

11. The client device of claim 8, wherein the machine-readable instructions when executed by the one or more processors are adapted to cause the client device to pass a security identifier with the transaction information to the remote location to permit the transaction information to be stored at the remote location.

12. The client device of claim 8, wherein the machine-readable instructions when executed by the one or more processors are adapted to cause the client device to:
provide a search request from the client device to the remote location; and
receive at the client device at least a portion of the transaction information from the remote location in response to the search request.

13. The client device of claim 8, wherein the remote location comprises a server of a payment service provider.

14. A machine-readable medium comprising a plurality of machine-readable instructions which when executed by one or more processors of a client device are adapted to cause the client device to provide a printer driver, wherein:
the printer driver is adapted to pass transaction information to a remote location to store the transaction information in a transaction record maintained at the remote location;
the printer driver is adapted to pass the transaction information in response to a user-initiated selection of the printer driver received by the client device; and
the transaction information is received by the client device and is associated with a user-merchant transaction.

15. The machine-readable medium of claim 14, wherein the machine-readable instructions when executed by the one or more processors are adapted to cause the client device to apply a timestamp to the transaction information before the transaction information is passed to the remote location.

16. The machine-readable medium of claim 14, wherein the machine-readable instructions when executed by the one or more processors are adapted to cause the client device to pass a security identifier with the transaction information to the remote location to permit the transaction information to be stored at the remote location.

17. The machine-readable medium of claim 14, wherein the machine-readable medium is a memory of the client device.

18. A method of managing transaction information, the method comprising:
maintaining a plurality of transaction records, the transaction records comprising transaction information associated with a plurality of user-merchant transactions;
receiving new transaction information from a client device in response to a triggering of a printer driver performed at the client device, wherein the new transaction information is associated with a new user-merchant transaction; and
storing the new transaction information in a new transaction record.

19. The method of claim 18, wherein the new transaction information comprises a receipt implemented as one of an email message, a webpage, or a graphic file.

20. The method of claim 18, further comprising:
receiving a security identifier from the client device; and
verifying the security identifier prior to the storing.

21. The method of claim 18, further comprising:
receiving a search request; and
serving at least a portion of the new transaction information in response to the search request.

22. The method of claim 21, further comprising:
receiving a security identifier; and
verifying the security identifier prior to the serving.

23. The method of claim 22, wherein the security identifier permits limited access to the new transaction record.

24. The method of claim 18, further comprising:
maintaining a plurality of user accounts comprising user financial information, wherein the transaction records are associated with the user accounts; and
providing the financial information of one of the user accounts to a merchant server to perform the new user-merchant transaction on behalf of a user associated with the user account.

25. A machine-readable medium comprising a plurality of machine-readable instructions which when executed by one or more processors of a server are adapted to cause the server to perform the method of claim 18.

26. A transaction record processing system comprising:
a plurality of transaction records associated with the user accounts, the transaction records comprising transaction information associated with a plurality of user-merchant transactions;
one or more processors; and
one or more memories adapted to store a plurality of machine-readable instructions which when executed by the one or more processors are adapted to cause the transaction record processing system to:
receive new transaction information from a client device in response to a triggering of a printer driver performed at the client device, wherein the new transaction information is associated with a new user-merchant transaction, and
store the new transaction information in a new transaction record.

27. The transaction record processing system of claim 26, wherein the new transaction information comprises a receipt implemented as one of an email message, a webpage, or a graphic file.

28. The transaction record processing system of claim 26, wherein the machine-readable instructions when executed by the one or more processors are adapted to cause the transaction record processing system to:
receive a security identifier from the client device; and
verify the security identifier before the new transaction information is stored in a new transaction record.

29. The transaction record processing system of claim 26, wherein the machine-readable instructions when executed by the one or more processors are adapted to cause the transaction record processing system to serve at least a portion of the new transaction information in response to a search request received by the transaction record processing system.

30. The transaction record processing system of claim 29, wherein the machine-readable instructions when executed by the one or more processors are adapted to cause the transaction record processing system to:
receive a security identifier; and
verify the security identifier before the at least a portion of the new transaction information is served.

31. The transaction record processing system of claim 30, wherein the security identifier permits limited access to the new transaction record.

32. The transaction record processing system of claim 26, further comprising:
a plurality of user accounts comprising user financial information;
wherein the machine-readable instructions when executed by the one or more processors are adapted to cause the transaction record processing system to provide the financial information of one of the user accounts to a merchant server to perform the new user-merchant transaction on behalf of a user associated with the user account; and
wherein the new transaction record is associated with the user account.
